(19) United States
(12) Patent Application Publication
(10) Pub. No.: US 2011/0273403 A1
(43) Pub. Date: Nov. 10, 2011

(54) PHOTO-SENSING LCD TOUCH DEVICE

(75) Inventors: Yi-ling Hung, Longtan Township (TW); Heng-chang Lin, Longtan Township (TW)

(73) Assignee: CHUNGHWA PICTURE TUBES, LTD., Bade City (TW)

(21) Appl. No.: 12/854,862

(22) Filed: Aug. 11, 2010

(30) Foreign Application Priority Data
May 4, 2010 (TW) 099114225

(51) Int. Cl. G06F 3/042

(52) U.S. Cl. 345/175

(57) ABSTRACT

A photo-sensing LCD touch device with a light guide plate is provided. The light guide plate is disposed in an LCD touch panel, and a light source is disposed on one side of the light guide plate to provide lights into the light guide plate, yielding an occurrence of total reflection of the lights in the light guide plate. When a touch object touches the light guide plate, the total reflection of the lights would be decomposed so that the lights are emitted out of the light guide plate. Therefore, a photo-sensor can detect a variance of a photo-current of the scattered lights to accurately determine a touched position. Accordingly, the LCD touch device would not rely on ambient light and can avoid a drawback of an undesirable shadow.

### TECHNICAL FIELD OF THE INVENTION

The present invention relates to a photo-sensing LCD touch device, and especially to a photo-sensing LCD touch device having a light guide plate.

### BACKGROUND OF THE INVENTION

In recent years, a human-machine interface such as a touch panel has been widely applied to a wide range of electronic products, e.g. a global positioning system (GPS), a personal digital assistant (PDA), a cellular phone and a hand-held PC to replace conventional input devices, e.g. a keyboard and a mouse, etc. The significant changes in the designs have not only improved the affinity of the above-mentioned human-machine interface of electronic devices, but also disused the conventional input devices so as to have more spaces to install a larger display panel for users to browse information more conveniently.

Furthermore, with the technology of a liquid-crystal display (LCD) panel industry rapidly leaping forward in recent years, production costs of the touch panels have significantly reduced. Therefore, the touch panel is gradually and widely used in general consumer electronics. The touch panel is a sensing unit and an input device being attached on the surface of a cathode-ray tube (CRT) or an LCD panel. Electric field changes of an indium tin oxide (ITO) glass and an (ITO) film on the touch panel are utilized to detect a touched position on the panel by a finger or an object and the relevant information is sent to an operating system of a computer. The touch panel has a feature of integration inputting and outputting, and a way of the inputting includes the following: a pen, a finger touch and a combination of the pen and the finger touch, and so on. Since the touch panel is disposed on the front of the screen, the screen images can be seen only when light penetrates the glass substrates, upper and lower conductive films and transparent films of the touch panel into the eyes. Therefore, all materials for manufacturing the touch panel must be pervious to light. Accordingly, a transparent glass is selected to be utilized as the substrate of a conventional touch panel.

In accordance with the technologies of the touch panel, the conventional touch panel can be categorized into the following types: a resistance type, a capacitive type, an infrared type, an acoustic type, an optical type, an electromagnetic type, an image recognition type, an embedded type, and other touch panel technologies.

The conventional touch panel being attached on the LCD panel has some drawbacks such as a great thickness and a low light transmittance. According to the embedded-type touch panel technology, currently, the sensing elements in the resistance type, the capacitance type or the optical type touch panel are integrated into the LCD panel manufacturing processes to overcome the above drawbacks. Meanwhile, the LCD panel manufacturers also hope to add some touch functions on the LCD panel so as to increase an extra value of the LCD panel. However, there are difficulties in the manufacturing processes of the embedded type touch panel at present, so the yield rate is low. Thus, the cost-effectiveness of the embedded type touch panel can not compare to the conventionally attached touch panel which has reached technology maturity.

In a shadow mode of the embedded-type touch panel technology, when a touch object touches the touch panel, ambient light such as a light source being provided by an external environment will be obscured by the touch object. Thus, a photo-sensor can detect light scattered by the obscured touch panel to determine a touched position thereof. However, when the touch object touches the touch panel, the light scattered from the touch panel is weak since the ambient light is weak. Moreover, when the photo-sensor can not clearly detect the light, or accurately determine the touched position, this will cause a touch failure. In addition, due to a considerable covering area of the touch object, the photo-sensor also can not accurately determine and can not generate a shadow of a specific point on the touch panel.

On the other hand, in a reflective mode, the light source is provided by the touch object reflecting a backlight. When the touch object touches the touch panel, the reflected light is scattered from the touch panel, the photo-sensor detects the scattered light to determine the touched position. However, when the ambient light intensity is too high, the reflective mode can not be triggered so that the reflection mode fails to work. In addition, when a low-brightness image is displayed by the LCD, the photo-sensor can not either accurately detect the light which is scattered by the touch object touching the panel. Accordingly, the touch function can not be achieved under the reflective mode.

Furthermore, if the reflective mode and the shadow mode both exist, it is not easy for the touch panel to switch from one mode to another since the touch panel relies on the ambient light intensity. Therefore, the results of the photo-sensor are computed by complex algorithms to make a determination. However, mis-determination is easily occurred so that the accuracy of recognition is reduced.

The photo-sensor in a conventional touch panel determines the touched position from a variance of a photo-current according to the ambient light when the touch object touches the panel, so that when the ambient light intensity is too weak or too strong, the detection capability of the photo-sensor will be affected and some errors or failures in determining the touched position will occur.

### SUMMARY OF THE INVENTION

In accordance with the sensing error drawback caused by the ambient light with the above-mentioned LCD touch device, one object of the present invention is to provide a light guide plate which is disposed on an LCD touch panel, and a light source which provides lights with sufficiently strong intensity to yield an occurrence of a total reflection of the lights in the light guide plate. When a touch object touches the light guide plate, scattered lights emitted from the light guide plate when the total reflection in the light guide plate is decomposed. Accordingly, a photo-sensor in the LCD touch panel can detect the scattered lights, and to determine a touched position of the touch object according to a variance of a photo-current corresponding to the scattered lights without depending on the ambient light source to avoid drawbacks such as an undesirable shadow.

Another object of the present invention is to employ a substrate of a color filter in the LCD touch panel as the light guide plate, so that the lights of the light source are emitted from one side of the substrate into the substrate. Thus, a total reflection of the lights is generated in the substrate. When a touch object touches the light guide plate, the scattered lights emitted from the light guide plate when the total reflection in the light guide plate is decomposed. Accordingly, the photo-sensor in the LCD touch panel can detect the scattered lights, so as to determine the touched position of the touch object according to a variance of the photo-current corresponding to the scattered lights without depending on an ambient light source. Therefore, the drawback of an undesirable shadow can be avoided.

In accordance with the above-mentioned objects, the present invention provides a photo-sensing LCD touch device including a backlight module, an LCD touch panel disposed on the backlight module, a light guide plate disposed on the LCD touch panel, and a light source disposed on one side of the light guide plate. The light source emits lights from the side of the light guide plate into the light guide plate, and a total reflection of the lights is generated in the light guide plate. A photo-sensor is disposed in the LCD touch panel for detecting scattered lights emitted from the light guide plate when the total reflection in the light guide plate is decomposed, wherein a touched position of the photo-sensing LCD touch device is determined in accordance with a variance of a photo-current corresponding to the scattered lights.

The present invention further provides a photo-sensing LCD touch device including a backlight module, an LCD touch panel disposed on the backlight module, and a light source disposed on one side of a substrate of a color filter in the LCD touch panel. The light source emits lights from the side of the substrate into the substrate, and a total reflection of the lights is generated in the substrate. A photo-sensor is disposed in the touch LCD touch panel for detecting scattered lights which are emitted from the substrate when the total reflection in the substrate is decomposed. A touched position of the photo-sensing LCD touch device is determined in accordance with a variance of a photo-current corresponding to the scattered light.

### BRIEF DESCRIPTION OF THE DRAWINGS

FIG. 1 is a side view schematically illustrating a photo-sensing LCD touch device according to an embodiment of the present invention.

FIG. 2 is a side view schematically illustrating a photo-sensing LCD touch device according to another embodiment of the present invention.

FIG. 3 is a side view schematically illustrating a photo-sensing LCD touch device according to still another embodiment of the present invention.

FIG. 4 is a side view schematically illustrating a photo-sensing LCD touch device according to yet another embodiment of the present invention.

FIG. 5 is a side view schematically illustrating a touch object touching a photo-sensing LCD touch device to generate photo sensing according to the present invention.

### DETAILED DESCRIPTION OF THE INVENTION

Reference will now be made in detail to the present preferred embodiments of the invention, examples of which are illustrated in the accompanying drawings.

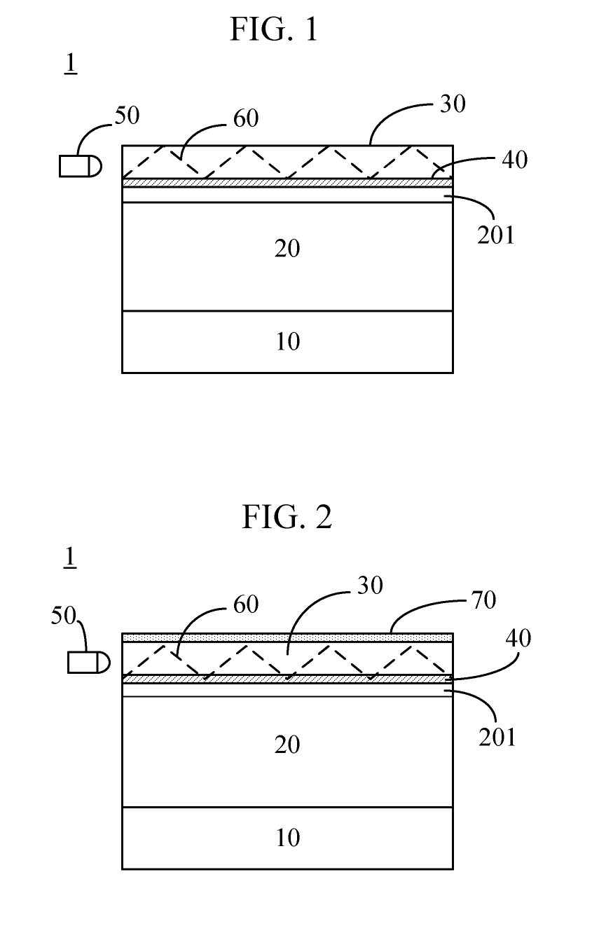

Referring to FIG. 1, FIG. 1 is a schematic view illustrating a photo-sensing LCD touch device according to an embodiment of the present invention. In FIG. 1, a photo-sensing LCD touch device 1 includes a backlight module 10, an LCD touch panel 20 and a light guide plate 30. The LCD touch panel 20 is disposed on the backlight module 10, and the light guide plate 30 is disposed on the LCD touch panel 20. A total reflection coating 40 is disposed between the light guide plate 30 and the LCD touch panel 20. It should be note that, in this embodiment, the LCD touch panel 20 is an embedded type LCD touch panel with a touch function, so the LCD touch panel 20 is different from the structure where a touch panel is attached on an LCD panel as described in the prior art. In addition, the structure of the embedded type LCD touch panel includes at least an array substrate, pixel electrodes, alignment films (not shown), liquid crystals (not shown), a color filter (not shown) and glass substrates (not shown), etc., which are all the same as in the structures and functions of the LCD panel in the prior art; hence, it is deemed unnecessary to provide redundant details in this embodiment.

In order to overcome the various drawbacks of the conventional LCD touch panel devices relying on the ambient light, according to the present invention, a light guide plate 30 is added in the LCD touch panel 20 of the LCD touch device 1 and especially at the top of a polarizer 201 of the LCD touch panel 20 without changing the circuit and the structure of the current LCD touch device 1. A light source 50 is disposed on one side (left or right are available) of the light guide plate 30, and then the light source 50 provides uniform lights with a predetermined intensity. Thus, the lights can be emitted into the light guide plate 30 from the side of light guide plate 30, and the light guide plate 30 guides a movement direction of the lights in the light guide plate 30 so that a total reflection of the lights (indicated by a dotted line 60) can be generated in the light guide plate 30. Moreover, the light guide plate 30 also has a property of controlling a brightness of the panel being uniform. In this embodiment, the light guide plate 30 is a hard light guide plate which is made of acrylic or glass. The light guide plate 30 should have the material characteristics of high reflectivity, light non-absorption, an appropriate refraction index fulfilling a condition of the total reflection and so on. Therefore, when the light source 50 emits the lights into the light guide plate 30, a total reflection 60 of the lights is generated in the light guide plate 30. In addition, the light source 50 disposed on the side of the light guide plate 30 comprises at least a single light-emitting diode (LED) or a bulb, and can be implemented by LEDs or bulbs arranged into an array or a module. The light source 50 is used to provide the lights with a sufficient intensity. The total reflection 60 is generated by the lights which are emitted into the light guide plate 30. In this embodiment, the form and type of the light source 50 are not limited. The total reflection 60 of is decomposed when the light guide plate 30 is touched, and thereby the lights are emitted from the surface of the light guide plate 30. Thus, a touch event is able to be detected, and further details are the following.

When a touch object (not shown), such as a finger, touches the light guide plate 30, especially the hard light guide plate, a stain or a fingerprint is easily left by the touch object on the light guide plate 30. Accordingly, the total reflection in the light guide plate 30 is decomposed at the position of the stain or the fingerprint on the light guide plate 30. Thus, a part of the lights are scattered from the light guide plate 30 even when there is no touch occurred on the light guide plate 30, so that a photo-sensor (not shown) mis-detects a touch occurred on the panel. Thus, a signal will be incorrectly outputted. Therefore, in another embodiment, an additional soft film 70 is disposed on the top of the hard light guide plate, and the material of the soft film 70 has a characteristic of a deformation recovery.

Referring to FIG. 2, FIG. 2 is a schematic view illustrating a photo-sensing LCD touch device according to another embodiment of the present invention. Similarly to FIG. 1, a photo-sensing LCD touch device 1 includes a backlight module 10, an LCD touch panel 20 and a light guide plate 30. The LCD touch panel 20 is disposed on the backlight module 10, and the light guide plate 30 is disposed in the structure of the LCD touch panel 20 and especially disposed on a polarizer 201 of the LCD touch panel 20. In addition, an additional soft film 70 is disposed on the top the hard light guide plate 30. A total reflection coating 40 is further disposed between the light guide plate 30 and the LCD touch panel 20 herein.

Similarly to FIG. 1, a light source 50 is disposed on one side (left or right are available) of the light guide plate 30, and then the light source 50 provides uniform lights with a predetermined intensity. Thus, the lights can be emitted into the light guide plate 30 from the side of the light guide plate 30, and a total reflection 60 (shown as dotted line 60) of the lights in the light guide plate 30 can be generated.

When a touch object touches the soft film 70 thereby affecting the light guide plate 30, the total reflection 60 in the light guide plate 30 is decomposed, and then the lights are emitted from the light guide plate 30 arising out of scattered lights. The scattered lights can be detected and transferred into a photo-current via a photo-sensor (not shown) of the LCD touch panel 20 which is a embedded type LCD touch panel with a touch function, and a actual touched position can be determined by a variance of the photo-current. After the touch object is off of the soft film 70, a deformation of the soft film 70 is eliminated to restore the original thickness of the soft film 70 (or the height of the soft film 70). The residual stain or fingerprint of the touch object (such as a finger) are only left on the soft film 70 instead of be left no the surface of the light guide plate 30. Therefore, when the total reflection is generated in the light guide plate 30, there is no residual stain or fingerprint on the surface of the light guide plate 30 to cause detection errors of the photo-sensor, thereby reducing its recognition.

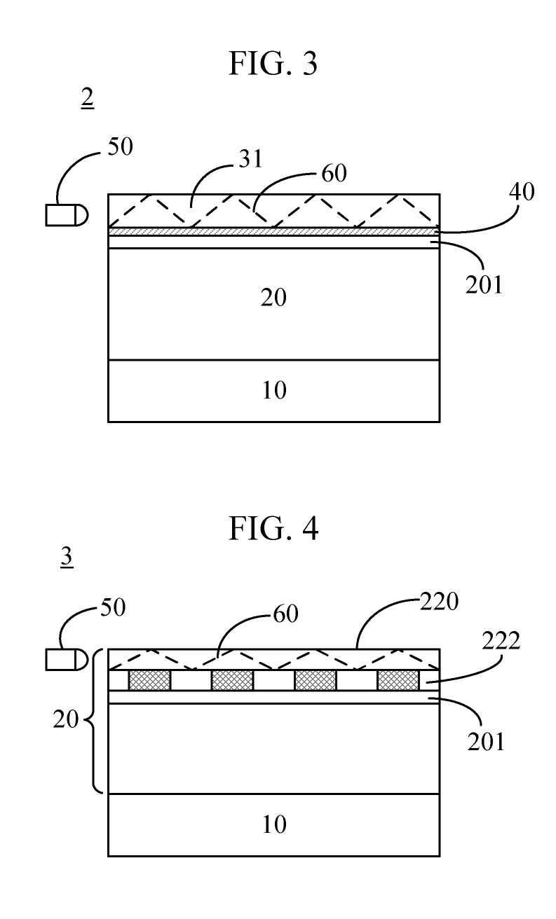

Next, referring to FIG. 3, FIG. 3 is a schematic view illustrating a photo-sensing LCD touch device according to still another embodiment of the present invention. In FIG. 3, a photo-sensing LCD touch device 2 includes a backlight module 10, an LCD touch panel 20 and a light guide plate 31. The LCD touch panel 20 is disposed on the backlight module 10, and the light guide plate 31 is disposed in the structure of the LCD touch panel 20 and especially disposed on a polarizer 201 of the LCD touch panel 20 with a touch function. A total reflection coating 40 is further disposed between the light guide plate 31 and the polarizer 201 herein. However, in this embodiment, the difference between the above-mentioned embodiments is that the light guide plate 31 disposed in LCD touch panel 20 is a soft light guide plate which is made of plastic or a membrane. The soft light guide plate 31 has material characteristics of deformation recovery and an appropriate refraction index fulfilling a condition of the total reflection.

Similarly, a light source 50 is disposed on one side (left or right) of the light guide plate 31, and then the light source 50 provides uniform lights with a predetermined intensity. Thus, the lights can be emitted into the light guide plate 31 from the side of light guide plate 31, and a total reflection (shown as dotted line 60) of the lights in the light guide plate 31 can be generated. Therefore, when a touch object (not shown) touches the light guide plate 31, the total reflection 60 in the light guide plate 31 is decomposed, and then the lights (i.e., scattered lights) are scattered from the light guide plate 31. The scattered lights can be detected and transferred into a photo-current via a photo-sensor (not shown) in an array substrate (not shown) of the LCD touch panel 20, and the actual touched position can be determined by a variance of the photo-current. After the touch object being off of the light guide plate 31, a deformation of the light guide plate 31 recovers to the original thickness (or height) of the light guide plate 31.

In addition, referring to FIG. 4, FIG. 4 is a schematic view illustrating a photo-sensing LCD touch device according to yet another embodiment of the present invention. In FIG. 4 in, a photo-sensing LCD touch device 3 includes a backlight module 10 and an LCD touch panel 20, where the LCD touch panel 20 is disposed on the backlight module 10. In this embodiment, a substrate 220 of a color filter 222 in the LCD touch panel 20 is directly used as a light guide plate, and a light source 50 is disposed on a side of the substrate 220 of the color filter 222. The substrate 220 is made of glass or acrylic. It should be note that, in this embodiment, the substrate 220 should have material characteristics of high reflectivity, light non-absorption, an appropriate refraction index fulfilling a condition of the total reflection and so on. Moreover, a wavelength of lights provided from the light source 50 must match the material characteristics of the substrate 220, so that the lights provided from the light source 50 can generate a total reflection in the substrate 220. Therefore, the lights with a uniform and a predetermined intensity provided from the light source 50 can be emitted into the substrate 220 from the side of the substrate 220, and a total reflection (shown as dotted line 60) of the lights in the substrate 220 can be generated.

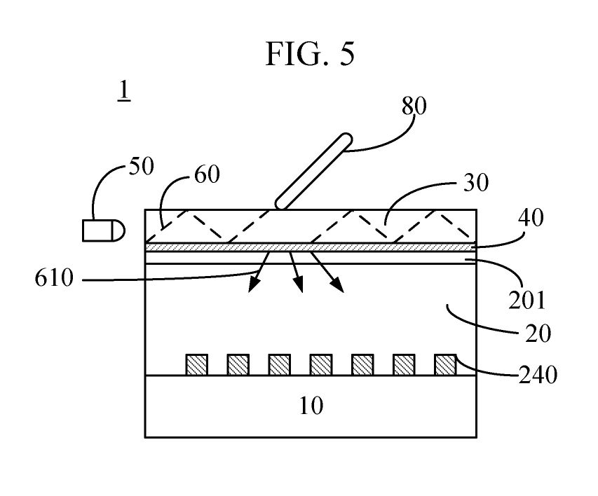

Finally, referring to FIG. 5, FIG. 5 is a schematic view illustrating a touch object touching a photo-sensing LCD touch device to generate a photo sensing according to the present invention. FIG. 5 illustrates the photo-sensing touch device 1 having a hard light guide plate in FIG. 1. When a touch object 80 touches the surface of the hard light guide plate 30 disposed in the LCD touch panel 20, the total reflection 60 in the light guide plate 30 is decomposed by the touch object 80. Thus, the lights can not form the total reflection 60 in the light guide plate 30, and the lights are emitted from the other side of the light guide plate 30 to generate scattered lights (i.e., denoted by 610). The scattered lights 610 can be detected and transferred into a photo-current by a processor via a photo-sensor 240 disposed in an array substrate (not shown) of the LCD touch panel 20, and an actual touched position can be determined by a variance of the photo-current. The processor can determine the actual touched position from the variance of the photo-current when the touch object 80 touches the light guide plate 30, thereby achieving the touch function.

Therefore, in accordance with the above mention, The main characterizes of the present invention is that an additional light guide plate is disposed on an LCD touch panel with touch function, or a substrate of a color filter is used as a light guide plate. Moreover, a light source is disposed on one side of the light guide plate to provide a uniform light with a predetermined intensity. Thus, lights can be emitted into the light guide plate, and a total reflection of the lights in the light guide plate can be generated. By the touch object interfering (or decomposing) the total reflection in the light guide plate (or the substrate of the color filter), the lights can be scattered out of the light guide plate, and a photo-sensor in an array substrate is used to detect the scattered lights. Therefore, both the shadow mode and the reflective mode do not rely on ambient light, and the drawback of an undesirable shadow can be avoided.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A photo-sensing LCD touch device comprising:
a backlight module;
an LCD touch panel disposed on the backlight module;
a light guide plate disposed on a polarizer of the LCD touch panel;
a light source disposed on one side of the light guide plate, the light source emitting lights from the side of the light guide plate into the light guide plate, a total reflection of the lights being generated in the light guide plate; and
a photo-sensor disposed in the LCD touch panel for detecting scattered lights emitted from the light guide plate when the total reflection in the light guide plate is decomposed;
wherein a touched position of the photo-sensing LCD touch device is determined in accordance with a variance of a photo-current corresponding to the scattering light.

2. The photo-sensing LCD touch device of claim 1, further comprising a total reflection coating disposed between the light guide plate and the polarizer.

3. The photo-sensing LCD touch device of claim 1, wherein the light guide plate comprises a hard light guide plate.

4. The photo-sensing LCD touch device of claim 3, wherein the hard light guide plate is made of acrylic or glass.

5. The photo-sensing LCD touch device of claim 3, further comprising a soft film formed on the hard light guide plate.

6. The photo-sensing LCD touch device of claim 1, wherein the light guide plate comprises a soft light guide plate.

7. The photo-sensing LCD touch device of claim 6, wherein the soft light guide plate is made of plastic or a membrane.

8. A photo-sensing LCD touch device comprising:
a backlight module;
an LCD touch panel disposed on the backlight module;
a light source disposed on one side of a substrate of a color filter of the LCD touch panel emitting lights from the side of the substrate into the substrate, and a total reflection of the lights being generated in the substrate; and
a photo-sensor disposed in the LCD touch panel for detecting scattered lights emitted from the substrate when the total reflection in the substrate is decomposed;
wherein a touched position of the photo-sensing LCD touch device is determined in accordance with a variance of a photo-current corresponding to the scattered light.

9. The photo-sensing LCD touch device of claim 8, wherein the substrate is made of acrylic or glass.

10. The photo-sensing LCD touch device of claim 8, wherein a wavelength of the lights provided from the light source is selected in accordance with material characteristics of the substrate thereby yielding an occurrence of a total reflection of the lights in the substrate when there is no touch occurred on the LCD touch panel.
